(19) United States
(12) Patent Application Publication
(10) Pub. No.: US 2014/0342861 A1
(43) Pub. Date: Nov. 20, 2014

(54) STATIONARY GUIDE FOR CHAIN TRANSMISSION

(71) Applicant: Tsubakimoto Chain Co., Osaka (JP)

(72) Inventors: Koichi Shimosaka, Osaka (JP); Atsushi Kawano, Osaka (JP); Atsushi Kumakura, Osaka (JP)

(21) Appl. No.: 14/452,686

(22) Filed: Aug. 6, 2014

Related U.S. Application Data
(63) Continuation-in-part of application No. 13/031,891, filed on Feb. 22, 2011.

(30) Foreign Application Priority Data
Mar. 4, 2010 (JP) 2010-047957

(51) Int. Cl. F16H 7/08

(52) U.S. Cl. CPC F16H 7/08; F16H 2007/0842
USPC 474/111

(57) ABSTRACT

A stationary guide for an engine timing chain is mounted by engagement of two longitudinally space mounting holes with two pins protruding from an engine block. At least one of the holes is formed with a stop wall positioned to prevent improper reverse mounting of the guide. The stop wall can be positioned to allow an amount of lateral sliding of the stationary guide, or can be positioned so that its abutment with the end of a mounting pin positions the guide in proper alignment with the normal path of travel of the timing chain.

### CROSS REFERENCE TO RELATED APPLICATIONS

This application is a continuation in part of U.S. patent application Ser. No. 13/031,891, filed Feb. 22, 2011. This application claims priority on the basis of Japanese Patent Application No. 2010-047957, filed on Mar. 4, 2010. The disclosures of Japanese Patent Application 2010-047957 and of U.S. application Ser. No. 13/031,891 are herein incorporated by reference.

### FIELD OF THE INVENTION

The invention relates to a stationary guide for use in a chain transmission such as the timing drive of an automobile engine, i.e., a transmission in which an endless transmission chain such as roller chain or a silent chain is engaged with and driven by a crankshaft sprocket and in driving relationship with one or more camshaft sprockets.

### BACKGROUND OF THE INVENTION

Stationary guides for guiding traveling timing chains by sliding contact therewith prevent vibration and swinging movement of the chain. A typical stationary guide, having two longitudinally spaced mounting holes for receiving mounting pins protruding from the wall of an engine block, is described in United States patent publication 2005/0096167, published on May 5, 2005.

Prior art stationary guides are typically mounted on two pins projecting from the engine block, and those pins have the same diameter. The pins P fit into two mounting holes portions 921 and 922, as shown in FIGS. 13, 14 and 15. Because the pins have the same diameter, and each of them can fit into either mounting hole in the guide, it is possible for the guide to be mounted backward, i.e., with its chain entry and chain exit ends reversed, as shown by the broken lines in FIGS. 13 and 14. The guide can also be mounted as shown in broken lines in FIG. 15, with its sliding contact surface facing away from the chain instead of in a position to come into sliding contact with the chain. The pins P, which protrude from a wall of an engine block B, should fit into the mounting holes 921 and 922 of the stationary guide 900 when the guide is correctly positioned as shown by solid lines in FIGS. 13, 14 and 15.

If the guide is mounted in a reversed position, as in FIGS. 13 and 14, the timing chain can travel incorrectly, generating abnormal noises and causing unexpected wear and damage to the guide. If the guide is mounted so that its sliding contact surface faces in the wrong direction as in FIG. 15, of course the guide will not operate at all.

### SUMMARY OF THE INVENTION

Aspects of this invention solve the aforementioned problems by avoiding erroneous mounting of a stationary guide with its chain entry end and chain exit ends reversed, thereby ensuring a normal locus of travel of the chain, and also by avoiding erroneous mounting of the stationary guide with its sliding contact surface facing away from the chain.

The stationary guide in accordance with the invention is incorporated into an engine comprising an engine block having first and second guide-supporting pins protruding therefrom in a protruding direction. Each of these pins has an outer end surface remote from the engine block. The engine also includes a timing chain transmission comprising a traveling timing chain, and a stationary chain guide for sliding engagement with the chain. The stationary chain guide comprises a rail for controlling travel of the timing chain. This rail has a longitudinal chain-engaging surface with opposite, parallel, longitudinally extending side edges, and an elongated rail support extending along the longitudinal direction of the rail and supporting the rail. The rail support has first and second, longitudinally spaced opposite ends and first and second longitudinally spaced mounting holes respectively receiving the first and second supporting pins. The first mounting hole is positioned closer to the first of the longitudinally spaced opposite ends than to a location midway between the opposite ends. Similarly, the second mounting hole is positioned closer to the second of the longitudinally spaced opposite ends than to the location midway between the opposite ends. The rail support is slidable on the first and second pins along the protruding direction of the pins.

At least the first mounting hole has an internal stop wall offset sufficiently to engage the second supporting pin and thereby prevent the rail support from being erroneously mounted on the supporting pins when an attempt is made to mount the rail support with the first supporting pin in the second mounting hole, the second supporting pin in the first mounting hole, and the longitudinal chain-engaging surface facing the timing chain, and also to prevent the rail support from being erroneously mounted on the supporting pins with the first supporting pin in the first mounting hole and the second supporting pin in the second mounting hole, and the longitudinal chain-engaging surface facing away from the timing chain. The internal stop wall is located on the side, opposite from the engine block, of an imaginary longitudinal plane perpendicular to the chain-engaging surface of the rail and situated midway between the side edges of the rail.

In an embodiment of the invention, the internal stop wall has a surface facing the engine block and capable of surface-to-surface abutment with the outer end surface of the first guide-supporting pin over a contact area. The internal stop wall is positioned within the first mounting hole at a location at which it is abutted by the first pin when the rail on the rail support is aligned with, and in normal sliding engagement with, the chain.

The internal stop wall can be advantageously positioned within the first mounting hole at a location at which it is abutted by the first supporting pin when the rail on the rail support is aligned with, and in normal sliding engagement with, the chain. Because the mounting pin abuts the internal stop wall, the guide can be aligned with the chain without special adjustment steps. In this embodiment, because the guide can be readily aligned with the normal locus of travel of the timing chain, it is possible to avoid noises that would otherwise be generated as a result of widthwise misalignment of the guide.

### BRIEF DESCRIPTION OF DRAWINGS

FIG. 1 is a schematic front elevational view of an engine timing transmission incorporating a stationary guide according to a first embodiment of the invention;

FIG. 2 is an exploded perspective view illustrating the mounting of the stationary guide of the first embodiment;

FIG. 3 is an exploded perspective view showing the mounting of the guide as in FIG. 2, but from the opposite direction;

FIG. 4 is a schematic elevational view showing the correct mounting of the stationary guide;

FIG. 5 is a schematic elevational view showing incorrect mounting of the stationary guide;

FIG. 6 is a front elevational view of the stationary guide of the first embodiment;

FIG. 7 is an enlarged fragmentary front elevational view showing the chain entry end of the stationary guide;

FIG. 8 is a cross-sectional view taken on section plane 8-8 in FIG. 7;

FIG. 9 is a schematic sectional view illustrating correct insertion of a mounting pin into a mounting hole of the guide according to the first embodiment;

FIG. 10 is a schematic sectional view illustrating an attempt to insert a mounting pin into a mounting hole of the guide according to the first embodiment when the guide is incorrectly positioned;

FIG. 11 is an exploded perspective view illustrating the mounting of a stationary guide according to an eighth embodiment;

FIG. 12 is an exploded perspective view showing the mounting of the guide as in FIG. 11, but from the opposite direction;

FIG. 13 is an exploded perspective view illustrating the correct and one mode of erroneous mounting of a conventional stationary guide;

FIG. 14 is an exploded perspective view showing the correct and erroneous mounting of the conventional guide as in FIG. 13, but from the opposite direction; and

FIG. 15 is an exploded perspective view illustrating the correct and a second mode of erroneous mounting of a conventional stationary guide.

### DETAILED DESCRIPTION OF THE PREFERRED EMBODIMENTS

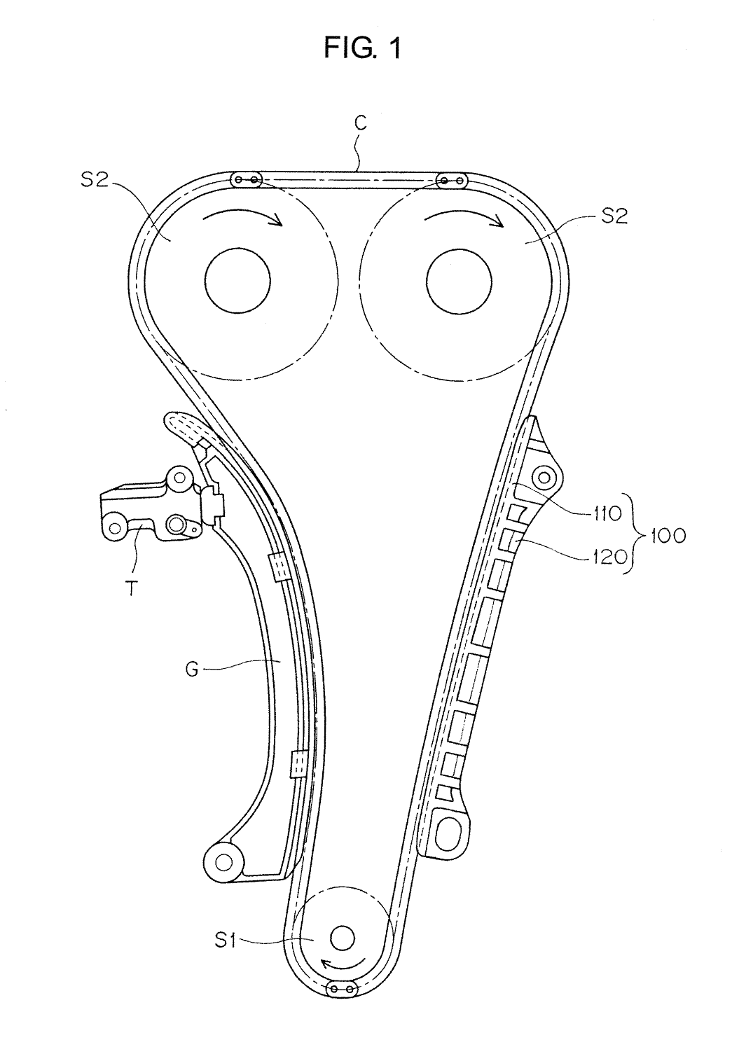

As shown in FIG. 1, a stationary guide 100 for an automobile engine timing chain is attached to a wall (not shown in FIG. 1) of an engine block. The timing chain C is a roller chain that transmits power from a crankshaft sprocket S1 to two driven camshaft sprockets S2. The guide 100 is in sliding contact with the chain and guides the travel of the chain.

FIG. 1 also shows a movable guide G that applies tension to the timing chain C. Guide G is in sliding contact with the side of the chain that travels from the driving sprocket S1 toward the driven sprockets S2. A tensioner T biases the movable guide G toward the chain in order to apply the tension to the chain.

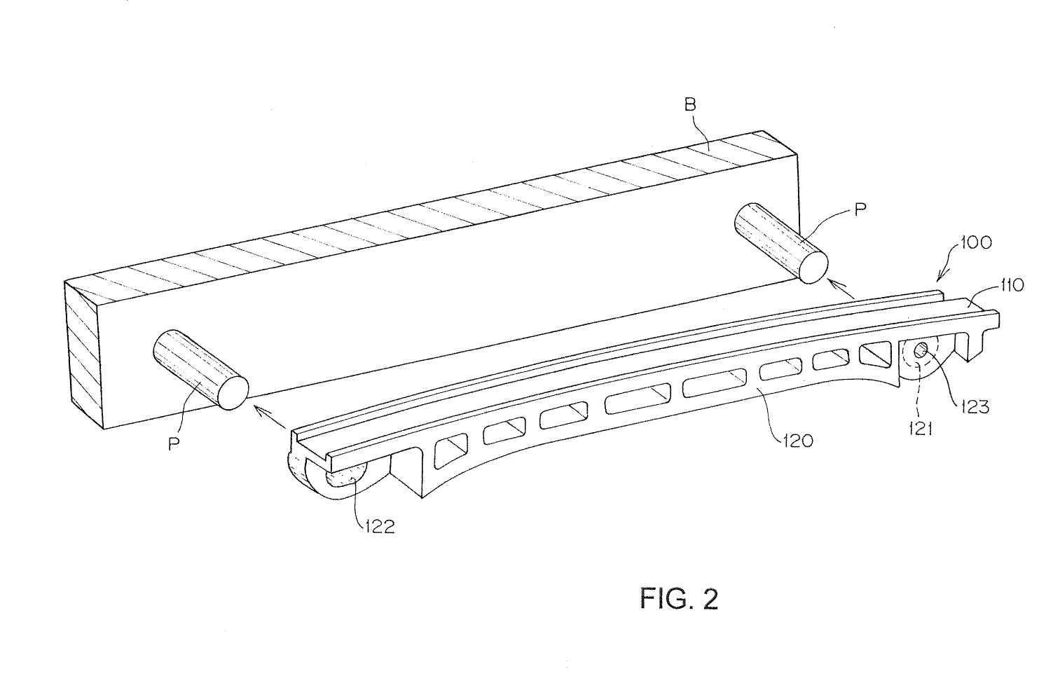

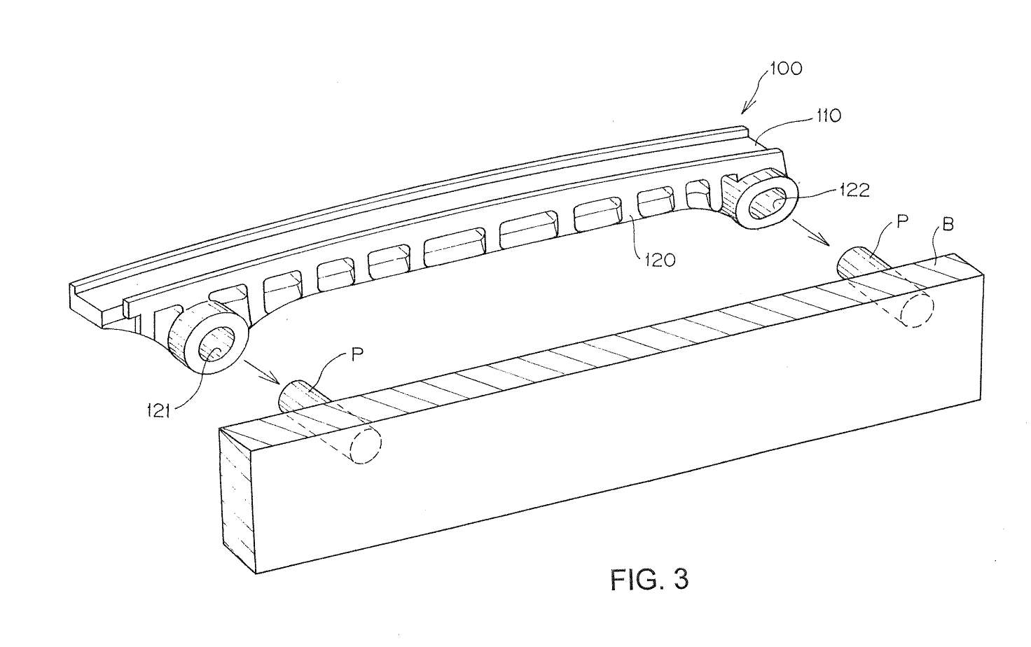

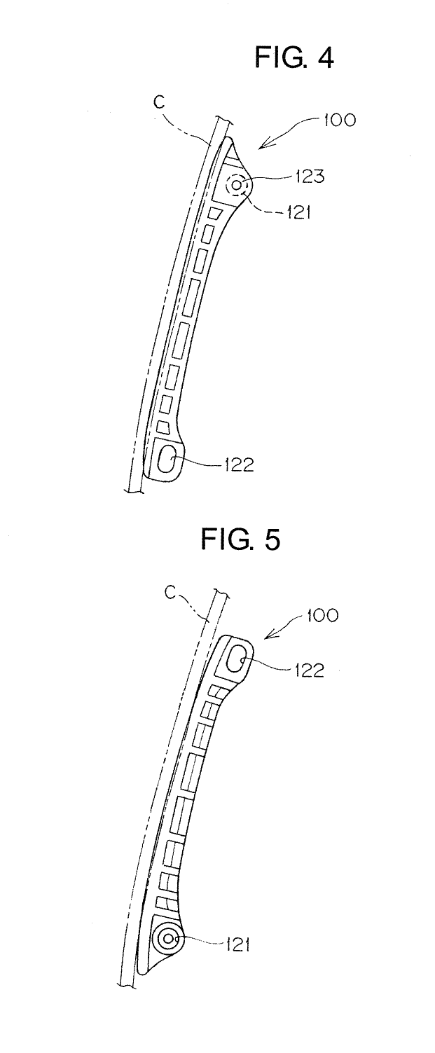

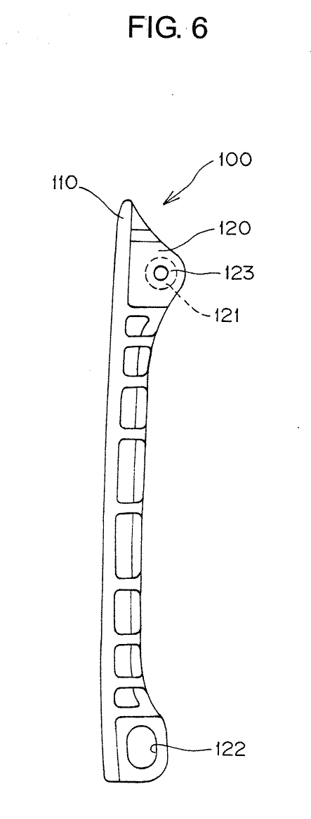

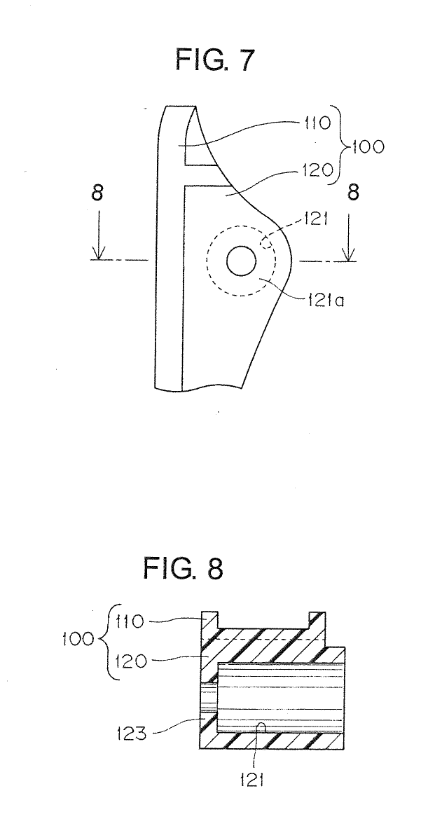

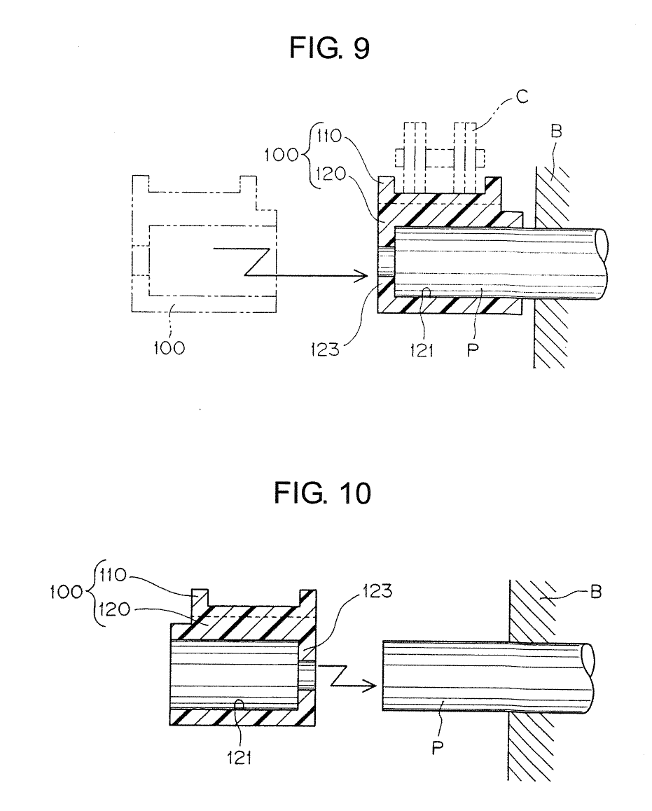

As shown in FIGS. 1 through 10, the stationary guide 100 includes a rail 110 for controlling the travel of the timing chain, and a rail support 120 for supporting the rail 110 so that the rail extends along the longitudinal direction of the portion of the chain with which it is in sliding contact. The rail support 120 is fixed to an engine block wall B (FIGS. 2-10) by fitting two holes, 121 and 122, in the rail support 120 respectively onto two supporting pins P projecting from the engine block wall B.

Whereas hole 121 is circular, hole 122 is an elongated hole having an oval cross-section, allowing for longitudinal expansion and contraction of the guide.

The hole 121 in the rail support 120 is provided with a cap-like stop wall 123. This stop wall 123 prevents the guide from being erroneously attached to the engine block wall in the reverse direction as shown in FIG. 5. If an attempt is made to insert pins P into holes 121 and 122 with the holes reversed, i.e., with the chain entry end where the chain exit end should be, and vice versa, a pin P abuts the cap-like stop wall 123 and is prevented from entering hole 121, as shown in FIG. 10.

The axial position of the stop wall 123 in hole 121 is such that it abuts the pin P when the guide is at the desired position, i.e., when the guide is properly aligned with the traveling path of the chain. Accordingly, it is unnecessary to take special measures to adjust the insertion depth of the mounting pin P in hole 121. The stop wall, therefore, not only makes it possible to avoid mounting the guide in reverse, i.e., with it chain exit end where the chain entry end should be, but also simplifies accurate alignment of the guide with the path of travel of the chain.

Because the guide can be readily positioned in alignment with the normal traveling locus of the timing chain, it is possible to reduce the noise that would otherwise be generated by contact between the chain and a sidewall of the guide due to shifting of the chain to one side in the widthwise direction. The stationary guide can be fixed against lateral movement on its supporting pins by any of various means, including contact with a timing chain cover (not shown).

In alternative embodiments (not illustrated), the stationary guide can be allowed to slide laterally on the mounting pins through a small range in order to accommodate quiver of the timing chain. If the guide is allowed to slide laterally, the width of the rail, i.e., the distance between the side walls of the rail, can be reduced, and the width of the rail support can also be reduced, thereby making it possible reduce the overall weight of the stationary guide.

If the stationary guide is allowed to move laterally on its supporting pins, its lateral movement can be limited by contact with a timing chain cover.

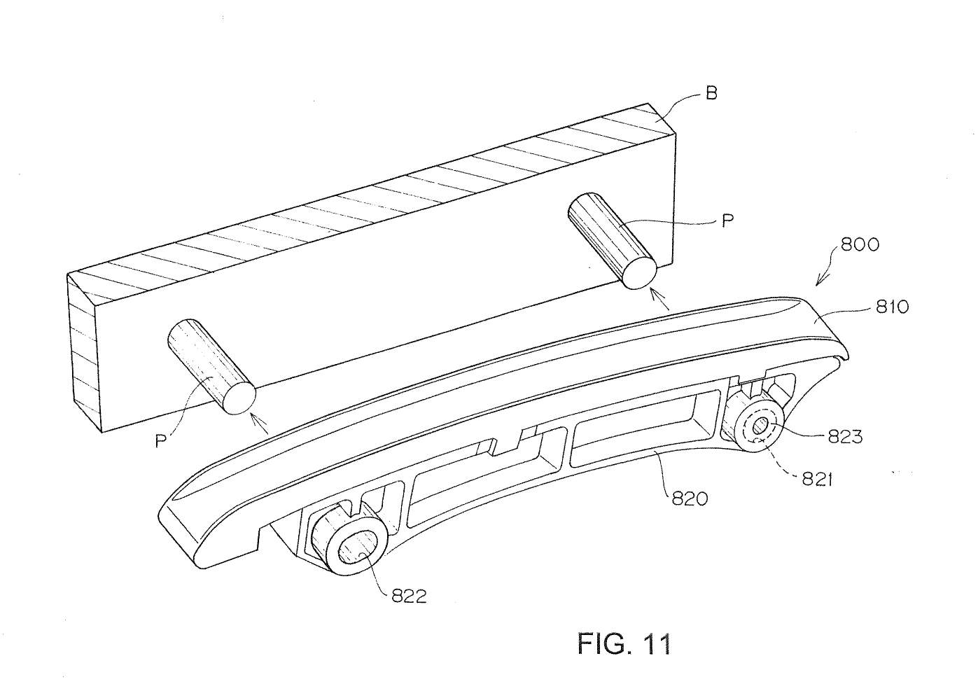

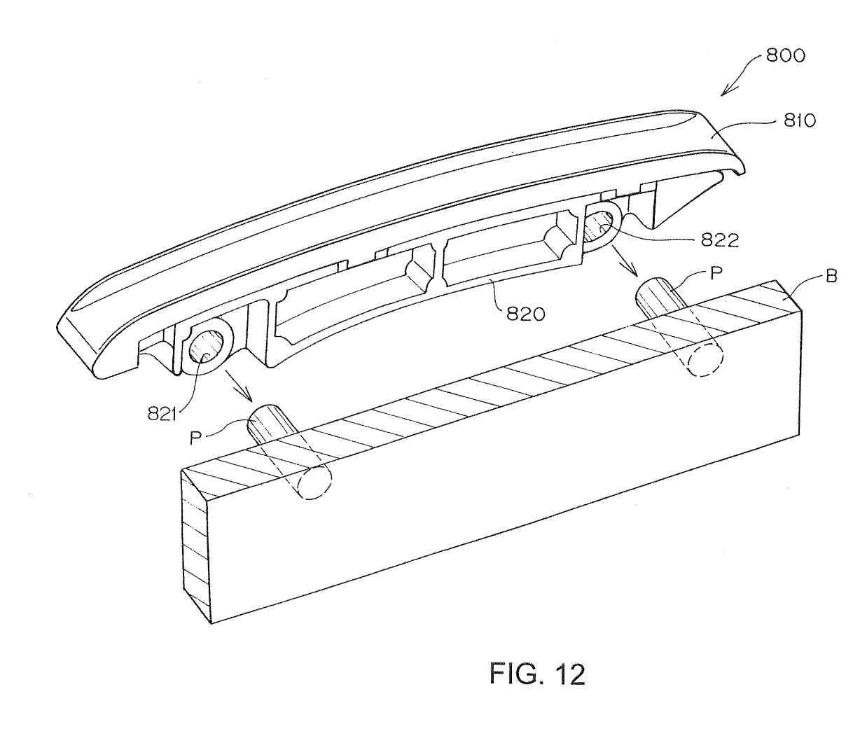

In another embodiment illustrated in FIGS. 11 and 12, the stationary guide 800 differs from the stationary guide of the previously described embodiment in the specific configurations of the rail and the rail support. The rail 810 for controlling the travel of the timing chain, C and the rail support 820, are supported on engine block wall B by fitting two holes 821 and 822 in the rail support 820 respectively onto two mounting pins P protruding from the engine block wall B. Hole 821 is provided with a cap-like stop wall 823 for preventing the stationary guide 800 from being erroneously mounted by reversal of the two holes 121 and 122.

The hole 822 is an elongated, oval-shaped hole whereas hole 821 is circular, in order to allow for longitudinal expansion and contraction of the guide. In this embodiment the rail 810 is formed separately from the rail support 820, and is a preferably a molded polymeric resin appropriately selected from polyamide resin, all aromatic resins, glass fiber-reinforced resins and the like. The rail differs from the rail support 820, which is preferably formed of metal, so that the coefficient of friction of the rail 810 against the timing chain C is reduced in comparison to the coefficient of friction in the case of a guide in which the rail and rail support are composed of the same metallic material. In this embodiment, the rail exhibits improved abrasion resistance and self-lubricating properties.

In both of the above-described embodiments, because the holes of the rail supports are provided with stop walls, it is easy to avoid erroneous assembly wherein the chain entry end and the chain exit end are reversed, and also easy to establish and maintain proper alignment of the guide with the normal path of chain travel.

The rail and rail support may be formed as a unit or separately. The specific configuration of the stop wall can be modified as long as it is provided at least in one of the mounting holes of the rail support and prevents the guide from being mounted erroneously. The hole having the stop wall can have an opening so that it is a through hole, or can be completely closed off by the stop wall. The specific position of the stop wall in its mounting hole can be varied as long as it prevents erroneous mounting of the guide on the mounting pins.

If the stop wall is positioned so that it is abutted by a mounting pin when the guide rail is properly positioned for alignment with the normal path of travel of the chain, adjustment of the insertion depth of the mounting pin becomes unnecessary.

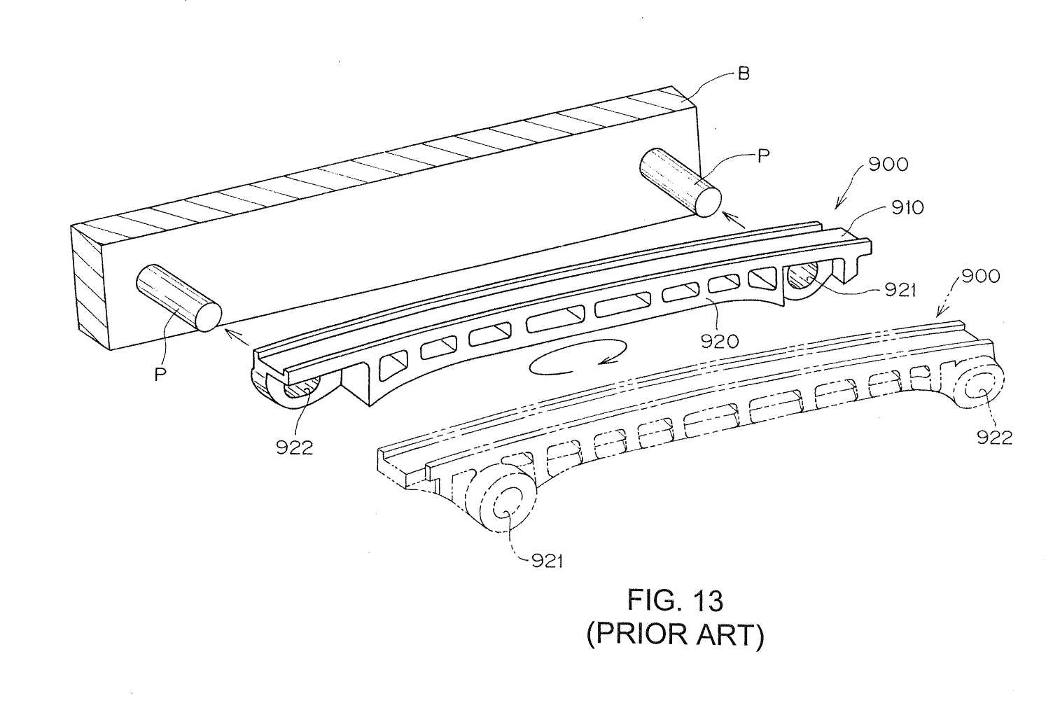

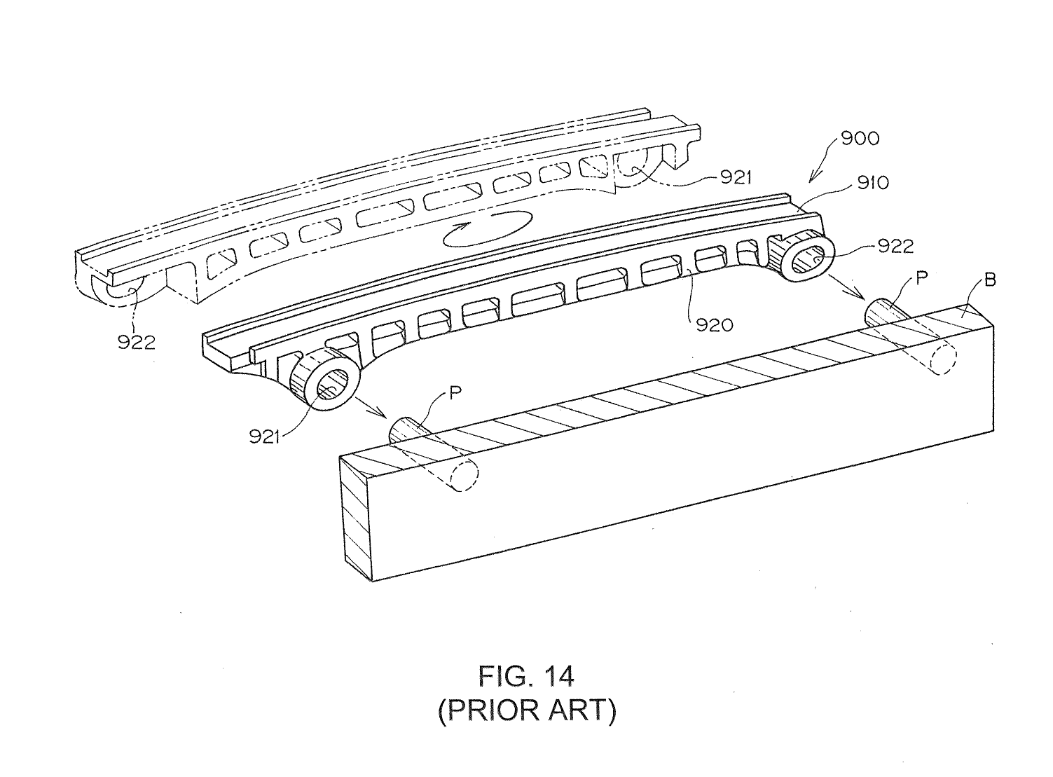

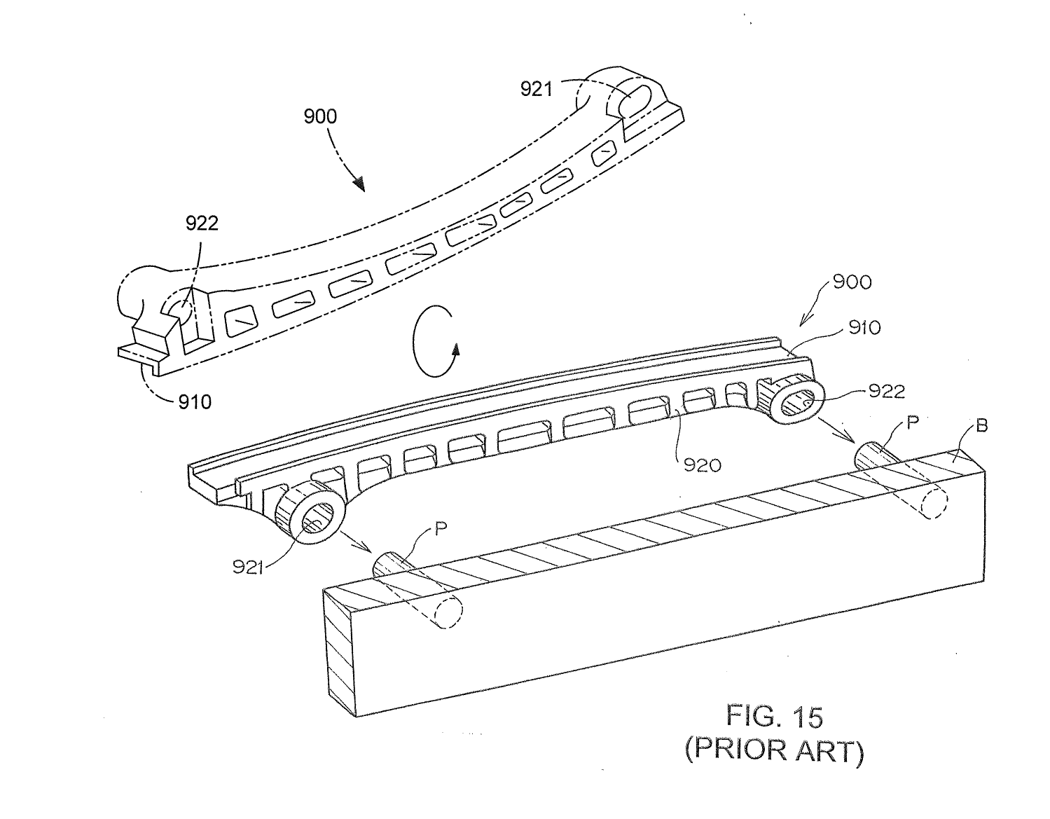

The stop wall in one of the mounting holes positively prevents the kind of reverse mounting illustrated in FIGS. 13 and 14, where the chain entry end of the guide is positioned where the chain exit end of the guide should be and vice versa. The stop wall also positively prevents the kind of reverse mounting illustrated in FIG. 15, where the chain-engaging surface of the guide faces away from the chain. A compound reverse mounting of the guide, in which the position of the chain entry end is interchanged with the position of the chain exit end, and at the same time the chain-contacting surface faces away from the chain, is still possible in the embodiments illustrated in FIGS. 1-12. However, compound reverse mounting is less likely to occur than either of the two kinds of simple reverse mounting shown in FIGS. 14 and 15. If compound reverse mounting is a concern, it can be avoided by using two mounting pins of different diameters, the diameter of the larger pin being larger than the diameter of the hole that fits the smaller pin when the guide is properly mounted.

What is claimed is:

1. In an engine comprising an engine block having first and second guide-supporting pins protruding therefrom in a protruding direction, each of said pins having an outer end surface remote from the engine block, a timing chain transmission comprising a traveling timing chain, and a stationary chain guide for sliding engagement with said chain, the stationary chain guide comprising:
a rail for controlling travel of said timing chain, the rail having a longitudinal chain-engaging surface with opposite, parallel, longitudinally extending side edges; and
an elongated rail support extending along the longitudinal direction of the rail and supporting the rail, said rail support having first and second, longitudinally spaced opposite ends;
wherein said rail support has first and second longitudinally spaced mounting holes respectively receiving said first and second supporting pins, said first mounting hole being positioned closer to said first of said longitudinally spaced opposite ends than to a location midway between said opposite ends, and said second mounting hole being positioned closer to said second of said longitudinally spaced opposite ends than to said location midway between said opposite ends;
wherein said rail support is slidable on said first and second pins along said protruding direction;
wherein at least said first mounting hole has an internal stop wall offset sufficiently to engage the second supporting pin and thereby prevent the rail support from being erroneously mounted on said supporting pins when an attempt is made to mount the rail support with the first supporting pin in the second mounting hole, the second supporting pin in the first mounting hole, and the longitudinal chain-engaging surface facing the timing chain, and also to prevent the rail support from being erroneously mounted on the supporting pins with the first supporting pin in the first mounting hole and the second supporting pin in the second mounting hole, and said longitudinal chain-engaging surface facing away from the timing chain; and
wherein said internal stop wall is located on the side, opposite from said engine block, of an imaginary longitudinal plane perpendicular to said chain-engaging surface the rail and situated midway between said side edges of said rail.

2. An engine according to claim 1, wherein said internal stop wall has a surface facing the engine block and capable of surface-to-surface abutment with the outer end surface of the first guide-supporting pin over a contact area, and wherein said internal stop wall is positioned within said first mounting hole at a location at which it is abutted by said first pin when the rail on said rail support is aligned with, and in normal sliding engagement with, said chain.
